(19) United States
(12) Patent Application Publication
(10) Pub. No.: US 2012/0212950 A1
(43) Pub. Date: Aug. 23, 2012

(54) LIGHT EMITTING UNIT

(75) Inventor: WEN-CHEN WEI, New Taipei (TW)

(73) Assignee: NENG TYI PRECISION INDUSTRIES CO., LTD., NEW TAIPEI CITY (TW)

(21) Appl. No.: 13/092,941

(22) Filed: Apr. 23, 2011

(30) Foreign Application Priority Data
Feb. 21, 2011 (TW) 100203087

(51) Int. Cl. F21V 29/00

(52) U.S. Cl. 362/218

(57) ABSTRACT

A light emitting unit includes a heat-dissipating base, at least one light-bar member and a cover member. The heat-dissipating base has a contact portion on one side thereof. The light-bar member has a PCB and a plurality of light emitting devices disposed on and electrically connected with the PCB. The light-bar member is disposed on the contact portion of the heat-dissipating base. The cover member is detachably assembled with the heat-dissipating base and covering the light-bar member. The cover member has an opening and the inner surfaces of two sides of the cover member respectively have a pressing portion. The pressing portion presses onto the PCB to contact the contact portion of the heat-dissipating base in a firm manner. Therefore, the heat generated by the light-bar member can be efficiently transferred to the heat-dissipating base so as to improve the heat-dissipating efficiency of the light emitting unit.

### BACKGROUND OF THE INVENTION

1. Field of the Invention

The instant disclosure relates to a light emitting unit; in particular, a light emitting unit having improved heat-dissipating efficiency.

2. Description of Related Art

LEDs have properties of small size, long life-time, high response rate, shock resistant and so on; therefore, LEDs are widely used in many applications. For example, LEDs have been developed and applied to the light-lamps so as to increase the usage of LEDs. Now, the LED lamps are used to replace for the traditional fluorescent lamps for the reason of environment protection.

A kind of LED lamps substantially has a heat-dissipating base, a light bar and a light cover. The heat-dissipating base is locked with the light cover, and the light bar is inserted into a slot formed inside the heat-dissipating base. By this structure of the LED lamp, the heat generated by the light bar can be transferred into the environment through the heat dissipating path defined by the heat-dissipating base, as published in Taiwan Patent No. M347522 of “LED LAMP”.

The light bar of the said LED lamp is simply sliding into the slot of the heat-dissipating base. For assembling, there is an air gap formed between the light bar and the heat-dissipating base. In other words, the light bar and the heat-dissipating base do not contact firmly with each other. As a result, the heat generated by the light bar cannot be transferred to the heat-dissipating base efficiently. Furthermore, due to the low heat-dissipating efficiency, the traditional LED lamp are failed to lower its lifetime.

Hence, the inventors of the present invention believe that the shortcomings described above are able to be improved and finally suggest the present invention which is of a reasonable design and is an effective improvement based on deep research and thought.

### SUMMARY OF THE INVENTION

One object of the instant disclosure is to provide a light emitting unit, which has a light-bar member contact firmly onto the heat-dissipating base. Therefore, the light emitting unit of the instant disclosure can be used to have an improved heat-dissipating efficiency.

The light emitting unit comprises a heat-dissipating base, at least one light-bar member and a cover member. The heat-dissipating base has a contact portion on one side thereof. The light-bar member has a PCB and a plurality of light emitting devices disposed on and electrically connected with the PCB. The light-bar member is disposed on the contact portion of the heat-dissipating base. The cover member is detachably assembled with the heat-dissipating base and covering the light-bar member. The cover member has an opening and the inner surfaces of two sides of the cover member respectively have a pressing portion. The pressing portion presses onto the PCB to contact the contact portion of the heat-dissipating base in a firm manner.

The instant disclosure mainly offers the cover member having two pressing portions formed on the inner surface thereof and the pressing portions is provided for abutting against the printed circuit board of the light-bar member. As a result, the pressed printed circuit board can be contact the contact portion of the heat-dissipating base in a firm manner. The heat generated by the light-bar member can be efficiently transferred to the heat-dissipating base. In other words, the light emitting unit provides for high heat-dissipating efficiency to dissipate the heat generated by the light-bar member to the environment. In hence, the light emitting unit of the present invention has better heat-dissipating effect than the traditional unit.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows the exploded view of the light emitting unit of the instant disclosure.

FIG. 2 shows the partial exploded view of the light emitting unit of the instant disclosure.

FIG. 3 shows the partial exploded view of the light emitting unit with the assembled heat-dissipating base, light-bar member and cover member of the instant disclosure.

FIG. 4 shows the cross-sectional view of the light emitting unit of the instant disclosure.

FIG. 5 shows the partial perspective view of the light emitting unit of the instant disclosure.

FIG. 6 shows the perspective view of the covering body of the light emitting unit of the instant disclosure.

FIG. 7 shows the perspective view of the light emitting unit of the instant disclosure.

### DETAILED DESCRIPTION OF THE PREFERRED EMBODIMENTS

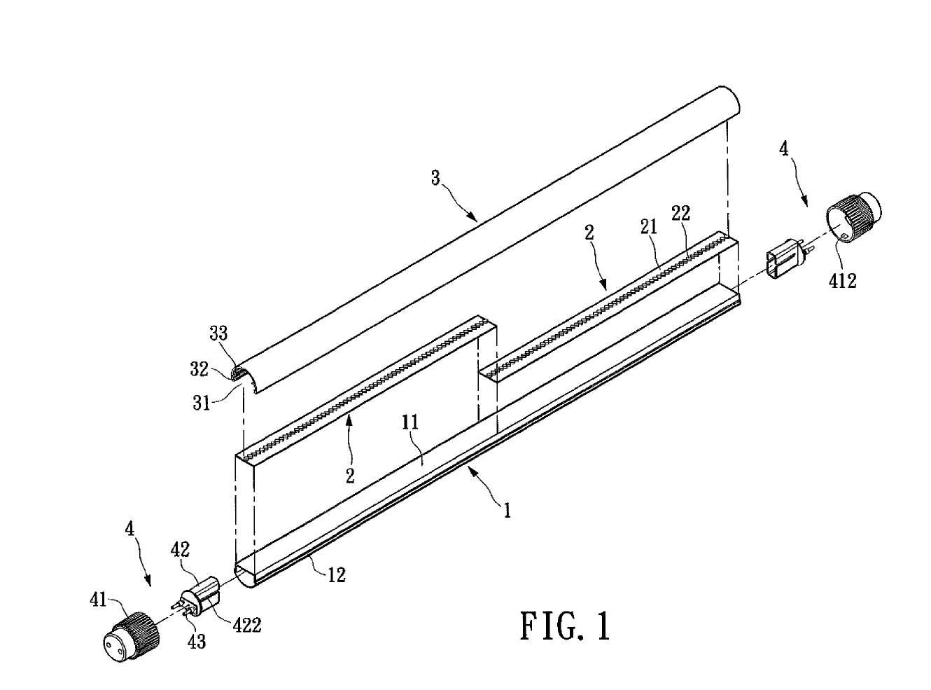

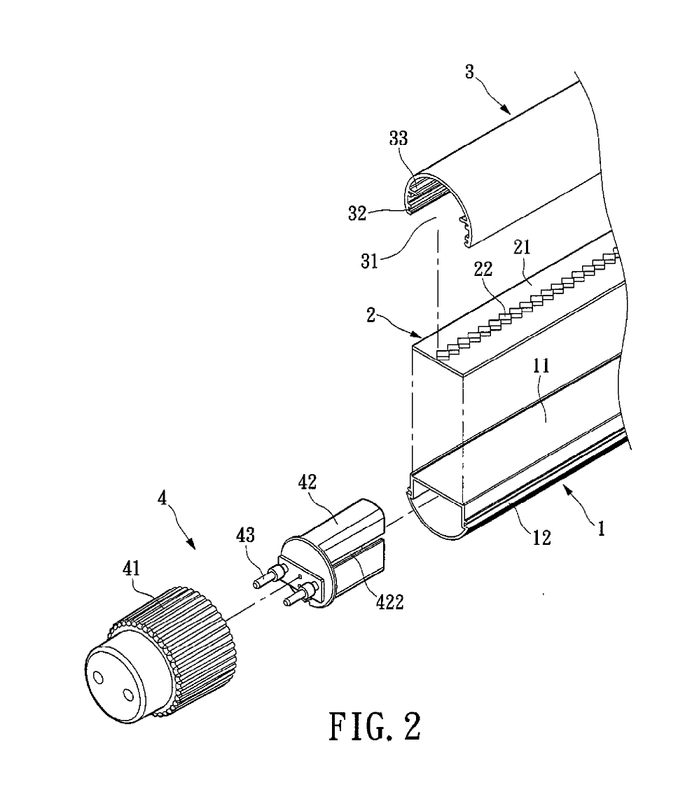

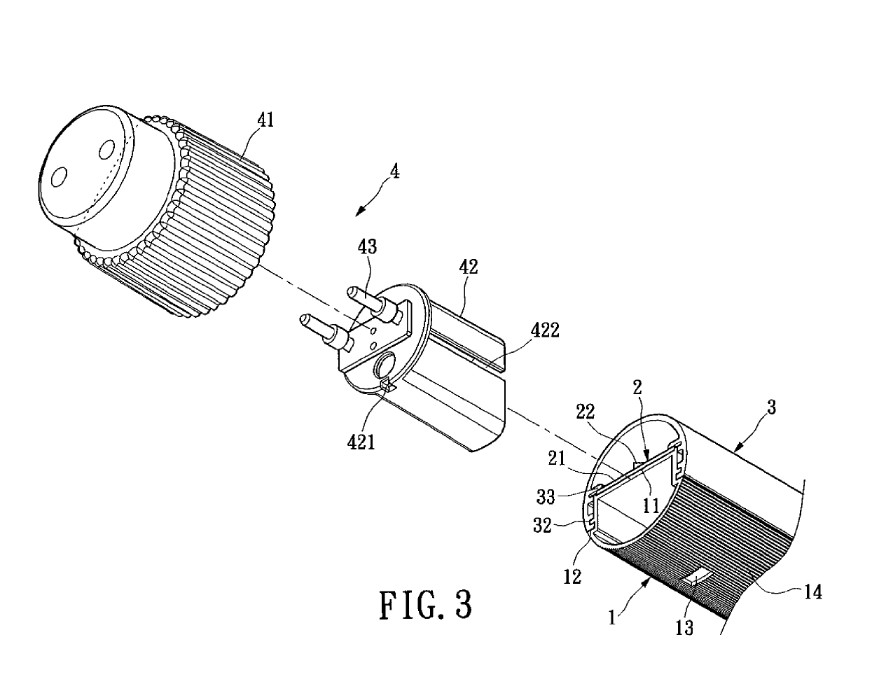

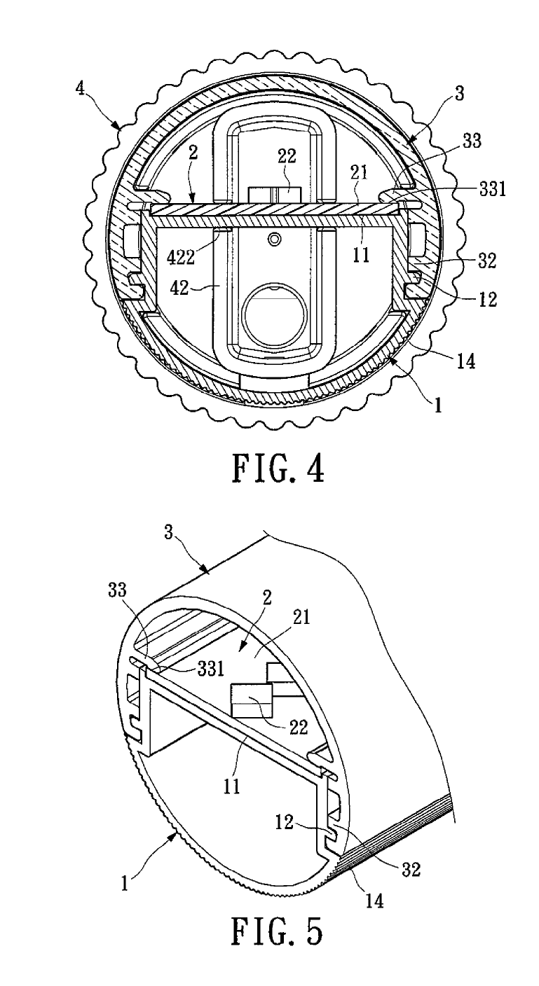

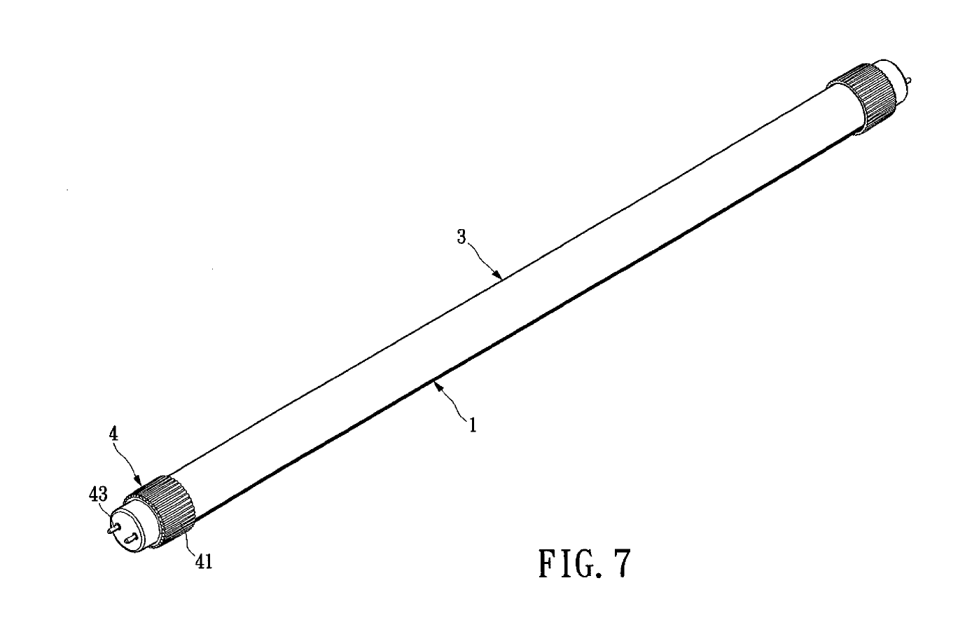

Please refer to FIGS. 1 to 7; the instant disclosure provides a light emitting unit which is constructed by a heat-dissipating base 1, at least one light-bar member 2 and a cover member 3. The heat-dissipating base 1 is made of materials with high heat conductivity, such as metals and is a hollow base with semi-cylindrical shape, but not restricted thereby. The heat-dissipating base 1 has a contact portion 11 formed on a first side thereof and the contact portion 11 is substantially an elongated planar surface. The heat-dissipating base 1 has a first locking portion 12 on outer surfaces of two sides thereof respectively, and the first locking portion 12 is formed and elongated along the longitudinal direction of the heat-dissipating base 1. In the exemplary disclosure, the first locking portion 12 may have stepped structures for engaging with the cover member 3. Two ends of the second side (i.e., the side opposite to the first side) of the heat-dissipating base 1 have two locking holes 13 respectively, as shown in FIG. 3. In addition, the external surface of the heat-dissipating base 1 is provided for a heat-dissipating portion 14, which can be convex-concave structures to improve the heat-dissipating efficiency.

The light emitting unit can includes one or two light-bar member 2. The light-bar member 2 includes a printed circuit board (PCB) 21 and a plurality of light emitting devices 22, such as light emitting diodes, disposed on and electrically connected with the printed circuit board 21. The printed circuit board 21 can be an elongated plate or an integrated-circuit board having circuits formed the surface thereof. For example, the printed circuit board 21 can be an aluminum substrate having circuits formed the surface thereof. The light emitting devices 22 are mounted on the printed circuit board 21 and facing to the cover member 3. Furthermore, the light emitting devices 22 are electrically connected to the circuits of the printed circuit board 21 and the number of the light emitting devices 22 can be adjusted in practice. The light-bar member 2 is disposed on the contact portion 11 of the heat-dissipating base 1. Specifically, the surface of the printed circuit board 21 without light emitting devices 22 thereon is provided for contact the contact portion 11 of the heat-dissipating base 1.

The cover member 3 can be made of transparent materials and can be a hollow casing having arc-surface or other shape, but not restricted thereby. The cover member 3 has an opening 31, and the inner surfaces of two sides of the cover member 3 respectively have a second locking portion 32. The second locking portion 32, as shown in FIG. 5, is elongated along the longitudinal direction of the cover member 3. In the exemplary embodiment, the second locking portion 32 can be stepped structures corresponding to the first locking portion 12, but not restricted thereby. Moreover, the inner surfaces of two sides of the cover member 3 respectively have a pressing portion 33 which is elongated along the longitudinal direction of the cover member 3. The pressing portion 33 protrudes on the inner surfaces of two sides of the cover member 3 with a length to force on the printed circuit board 21 of the light-bar member 2. In the exemplary embodiment, the pressing portion 33 has a protrusion 331 extended toward the printed circuit board 21 on one end in close to the printed circuit board 21, and the pressing portion 33 contacts to and forces on the printed circuit board 21 by the protrusion 331.

The second locking portion 32 of the cover member 3 is engaged to the first locking portion 12 of the heat-dissipating base 1 so that the cover member 3 can be detachably assembled with the heat-dissipating base 1. On the other hand, the cover member 3 covers the light-bar member 2 and the lights generated from the light emitting devices 22 can project through the cover member 3. While assembling the cover member 3 onto the heat-dissipating base 1, the protrusion 331 of the pressing portion 33 presses on the printed circuit board 21 of the light-bar member 2. Therefore, the printed circuit board 21 of the light-bar member 2 can contact the contact portion 11 of the heat-dissipating base 1 in a firm manner.

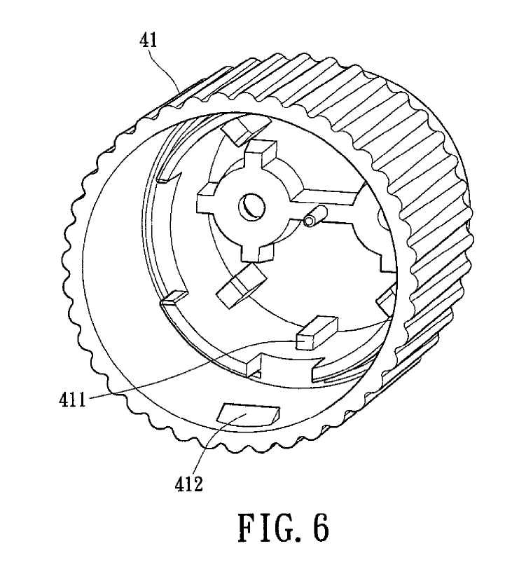

The light emitting unit further has two side-covering units 4 which are respectively disposed on two ends of the assembled heat-dissipating base 1, light-bar member 2 and cover member 3. Each side-covering unit 4 has a covering body 41, an insulating seat 42 and two conducting terminals 43. The covering body 41 can be a circular member and made of opaque materials to prevent the lights projecting through the two ends of the assembled heat-dissipating base 1, light-bar member 2 and cover member 3. The insulating seat 42 can be made of insulating materials, such as plastics, and the insulating seat 42 can be a hollow member. The insulating seat 42 can be inserted into the covering body 41. For assembling, the insulating seat 42 and the covering body 41 have corresponding assembling slots 421 (as shown in FIG. 3) and assembling protrusions 411 (as shown in FIG. 6). The two conducting terminals penetrate through the covering body 41; therefore, the out ends of the conducting terminals can be inserted into an external connector and the inner ends of the conducting terminals can be electrically connected to the light-bar member 2 by conductive wires.

The covering bodies 41 of the side-covering units 4 are covered on two ends of the assembled heat-dissipating base 1 and cover member 3. In the embodiment, the covering body 41 has two locking protrusions 412 (as shown in FIG. 6) corresponding to two locking holes 13 of the heat-dissipating base 1. Each locking protrusion 412 is engaged with the corresponding locking hole 13 so that the side-covering unit 4 can be fixedly secured onto the end of the assembled heat-dissipating base 1 and cover member 3. Furthermore, each insulating seat 42 has two grooves 422 on the opposite sides thereof and the end of the connected contact portion 11 and the PRINTED CIRCUIT BOARD 21 can be inserted inside the grooves 422. Therefore, the side-covering units 4 can be firmly secured on the assembled heat-dissipating base 1 and cover member 3.

In summary, the cover member 3 has two pressing portions 33 formed on the inner surface thereof and the pressing portions 33 is provided for abutting against the printed circuit board 21 of the light-bar member 2. As a result, the pressed printed circuit board 21 can be contact the contact portion 11 of the heat-dissipating base 1 in a firm manner. The heat generated by the light-bar member 2 can be efficiently transferred to the heat-dissipating base 1. In other words, the light emitting unit provides for high heat-dissipating efficiency to dissipate the heat generated by the light-bar member 2 to the environment. In hence, the light emitting unit of the present invention has better heat-dissipating effect than the traditional unit.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A light emitting unit, comprising:
a heat-dissipating base, the heat-dissipating base having a contact portion on one side thereof;
at least one light-bar member, the light-bar member having a PCB and a plurality of light emitting devices disposed on and electrically connected with the PCB, the light-bar member being disposed on the contact portion of the heat-dissipating base; and
a cover member detachably assembled with the heat-dissipating base and covering the light-bar member, wherein the cover member has an opening, the inner surfaces of two sides of the cover member respectively have a pressing portion, the pressing portion presses onto the PCB to contact the contact portion of the heat-dissipating base in a firm manner.

2. The light emitting unit of claim 1, wherein the heat-dissipating base has a first locking portion on outer surfaces of two sides thereof, respectively; the inner surfaces of two sides of the cover member respectively have a second locking portion, and the first locking portion is engaged with the second locking portion.

3. The light emitting unit of claim 1, wherein the heat-dissipating base has a heat-dissipating portion on the outer surface thereof.

4. The light emitting unit of claim 1, wherein the pressing portion extends in the longitudinal direction of the cover member.

5. The light emitting unit of claim 4, wherein the pressing portion has a protrusion extended toward the PCB on one end in close to the PCB, and the pressing portion contacts to the PCB by the protrusion.

6. The light emitting unit of claim 4, wherein the heat-dissipating base has a first locking portion on outer surfaces of two sides thereof, respectively; the inner surfaces of two sides of the cover member respectively have a second locking portion, and the first locking portion is engaged with the second locking portion.

7. The light emitting unit of claim 4, wherein the heat-dissipating base has a heat-dissipating portion on the external surface thereof.

8. The light emitting unit of claim 1, further comprising two side-covering units, the two side-covering units are respectively disposed on two ends of the assembled heat-dissipating base, light-bar member and cover member.

9. The light emitting unit of claim 8, wherein each of the two side-covering units includes a covering body, an insulating seat received inside the covering body and two conducting terminals disposed on the covering body, the covering body is an opaque member, the covering bodies of the two side-covering units are respectively disposed on two ends of the assembled heat-dissipating base and cover member, the insulating seat has at least one assembling slot, the covering body has at least one assembling protrusion which is correspondingly engaged to the assembling slot, the conducting terminals are electrically connected to the light-bar member.

10. The light emitting unit of claim 9, wherein two ends of the opposite side of the heat-dissipating base have two locking holes respectively, the covering body has at least one locking protrusion corresponding to each locking hole, the locking protrusion is engaged to the locking hole.

11. The light emitting unit of claim 9, wherein the insulating seat has two grooves on the opposite sides, the contact portion of the heat-dissipating base and the PCB of the light-bar member are inserted inside the grooves.
